(19) United States
(12) Patent Application Publication
(10) Pub. No.: US 2011/0020771 A1
(43) Pub. Date: Jan. 27, 2011

(54) ELECTRONIC BRAILLE TYPING INTERFACE

(76) Inventors: Ryan M. Rea, Santa Paula, CA (US); David Morgan, Watertown, MA (US)

Correspondence Address: KOPPEL, PATRICK, HEYBL & DAWSON, 2815 Townsgate Road, SUITE 215, Westlake Village, CA, 91361-5827, US

(21) Appl. No.: 12/687,047

(22) Filed: Jan. 13, 2010

Related U.S. Application Data
(60) Provisional application No. 61/228,087, filed on Jul. 23, 2009.

(51) Int. Cl. G09B 21/02

(52) U.S. Cl. 434/114

(57) ABSTRACT

A user interface system for entry of Braille input to electronic devices comprises a module with a single set of six tactile keys arranged in a 6 dot Braille configuration. The user interface system is configured to recognize data entered therein by user contact with one or more of the tactile keys as Braille input and to transmit said Braille input to an electronic device for display or further transmission. The interface further includes function keys which allow the user to manipulate, modify, or otherwise control the data entered and how the data is transmitted.

This application claims the benefit of provisional application No. 61/228,084 to Rea et al., filed Jul. 23, 2009.

### BACKGROUND

1. Field of the Invention

This invention relates to an electronic Braille interface and more particularly a Braille interface incorporating a single set of 6 input cells for input of Braille characters into an electronic system.

2. Description of the Related Art

Braille is a widely used method by blind or visually impaired people to read and write. It was conceived of by Louis Braille in 1821. Since the advent of Braille, the visually impaired, the world over, have adopted Louis Braille's universal multiple “6 dot Braille Cell” or some variation thereof. The 6 dot Braille Cell traditionally comprises a vertical rectangle that is equally split into two columns, extending from the top to the bottom of the vertical rectangle.

6 Dot Braille has traditionally had the following universal dimensions:
a. A dot height of approximately 0.5 mm
b. Horizontal and vertical spacing between the dot centers with the Braille cell approximately 2.5 mm apart
c. The blank space between dots on adjacent cells is approximately 3.75 mm horizontally and 5.0 mm vertically.

As shown in FIG. 1, 6 dot Braille consists of multiple, discrete, 6 dot Braille cells consisting of up to six raised dots arranged in a grid of two dots horizontally by three dots vertically. The dots are numbered 1, 2 and 3 from the top of the left column and 4, 5 and 6 from the top of the right column. To use a 6 dot Braille entry device such as shown in FIG. 1 a user depresses appropriate six dot positions to form any of sixty-four potential Braille permutations, including the arrangement in which no dots are raised. For example, when the user depresses dots 1 and 3, in the left column and number 4, in the right column of the 6 dot Braille Cell, referring to the Braille alphabet shown in FIG. 2, the letter “m” is generated.

To make a capital letter the Braille “capital sign” is generated in 6 dot Braille by depressing dot 6, on the 6 dot Braille Cell, prior to depressing the dots representing the letter desired to be capitalized. For example, if the user wants to generate a capital letter “A” dot 6, on the 6 dot Braille Cell is first depressed followed by depressing the number “1” dot. To capitalize an entire term, the user enters two Braille capital signs in front of the term to indicate that the entire term is to be capitalized.

Numbers are generated by the entering the number sign by depressing the 3, 4, 5, and 6 dots followed by the desired number. Numbers “1” through “9” and “0” correspond to the first ten letters of the alphabet. For example, the number “1” is indicated by the depression of the letter “a,” whereas the number “0” is indicated by the depression of the letter “j.” Double-digit numbers are indicated by depressing the number sign followed by a “string” of numbers.

For example, the number 10 is expressed by depressing the number sign—i.e. 3, 4, 5 and 6—followed by depressing the letters “a” and “j.” Moreover, three digit numbers, for example, the integer 193, would be expressed by the user depressing the number sign and then depressing letters “a,” “i” and “c”—i.e. numbers “1,” “9” and “3,” respectively.

“6 dot Braille Punctuation” is generated by the user depressing particular 6 dot Braille punctuation permutations in order to indicate particular Roman alphabet punctuation mark(s) and/or symbol(s). For example. If the user wishes to insert a “full stop” or period at the end of a sentence, dots 2, 5 and 6, on the 6 dot Braille Cell, are depressed at the end of a sentence.

FIG. 2 shows an alphabet that has been established using various dots arranged to represent each letter in the alphabet. Other arrangements of dots (not shown) have been established to represent numbers, punctuation marks, capital letters and other symbols or functions necessary to generate or represent written words and sentences. Referring to FIG. 2, to allow an individual to read a Braille document each letter, number, symbol, etc. in a Braille cell is comprised of dots raised above the surface of the document so that a combination of raised does presented in a linear array can be sensed by the fingertips of the Braille reader.

Besides providing a letter by letter Braille message, “6 dot Braille Contractions”, which are word truncations or abbreviations, have also been established for common expressions. For example, with the exception of letters “x” and “y”, there are common “whole words” that are represented a single letter, separate symbols, certain letter combinations alone or with symbols as well as contractions which use an “escape” character and/or letter. For example the 6 Dot Braille Contraction for “knowledge” is the letter “k.”

All of the letters of the 6 dot Braille alphabet (with the exception of “X” and “Y”, when separate from other letters, represent a whole word. Contractions are an important shortcut in creating a simple, user-friendly, electronically assisted tactile 6 Dot Braille typing user-interface.

In “Grade II English Braille,” the American Edition, there are 250 symbols or combinations of symbols for different abbreviated terms, punctuation marks, composition signs, numerals, contractions, single-cell words and short form terms. For example, in 6 dot Braille the commonly used whole word “about” can be expressed by depressing in series the letters “a,” and “b.” Contractions are capable of being strung together to make common phrases and even complete sentences. Another example of a whole word contraction is the word “for,” expressed in 6 dot Braille by depressing all 6 dots in a 6 dot Braille cell that has the feel of a printed surface of a 6 dot Braille cell with all 6 dots raised.

### Prior Braille Entry Devices

The earliest mechanical devices were typewriters which caused the individual Braille cells to be imprinted on a paper in place of the typed letters. Braille assisted technologies have been in use for over two decades. Many of these technologies have excessive manufacturing costs, non-user friendly designs and lack of ergonomic typing user-interfaces. For the most part, these problems are due to these technologies using excessive i.e. 40 to 120 discrete 6 dot Braille entry cell arrays for data input and data output.

A prior device has the general appearance of a typewriter or computer keyboard, is used by a visually impaired user depressing or running their fingers across multiple, individual and discrete, 6 dot Braille Cells until they have made a string of 6 dot Braille characters or symbols. For example, an individual using such a device would begin, from the left to the right, by depressing individual metal pins, numbering 1-6, on discrete multiple 6 dot Braille Cells, until the user either completes a sentence or a fragment of a sentence to be completed. Depending upon the technology, there may be voice output of key entries and voice input verification add-on features designed to attempt to make these technologies more user-friendly and ergonomic.

After the user completes a sentence or fragment of a sentence to be completed, the information is either typed out and/or saved on a hard drive. The user can then mechanically or electro-mechanically “refresh” the discrete 6 dot Braille cells for additional data input or data output. Typically, the reason why these devices are cost prohibitive is because of the excessive expenses related to incorporating so many discrete 6 Dot Braille cells into a multi 6 dot Braille Cell user-interface.

The reason why several mechanical and/or electromechanical refreshable Braille display products have multiple 6 Dot Braille Cell keyboard-like interfaces is because it is believed to save the visually impaired time while reading and writing. For this reason, historically, Braille cells have been almost exclusively “refreshable”, meaning, each time a user depresses particular metal pins, within various discrete 6 dot Braille cells, the depressed metal pins in the discrete cells must be refreshed, or brought back to their original uniform “set position” height in order for the user to be able to type or read any further data into the same multiple 6 dot Braille Cells.

The prior art device described above shows a traditional 6 dot Braille Cell raised metal pin “refreshable display.” Again, in order for the visually impaired user to type or read additional data, after exhausting the string of 40-120 discrete 6 dot Braille Cells on a refreshable Braille display, they either mechanically or electro-mechanically refresh all depressed 6 dot Braille metal pins to their original set position height.

Refreshable Braille display technologies have been in vogue for several decades. Traditionally, the problem with refreshable Braille displays has been that they are characteristically not user-friendly, far too expensive and not ergonomic. Much of the manufacturing costs for such technologies is incurred by building the many discrete refreshable 6 Dot Braille Cell displays that are ultimately packaged into one piece of hardware with limited space for the cells. The large size of the product is also due to the need to accommodate the many discrete 6 Dot Braille Cells into the keyboard-like multiple discrete 6 dot Braille cell user interface.

Electronic devices such as PDAs have been used by the sight community for well over two decades. Starting in the 1980's, mini “flip” cellular telephones and more recently modern handheld fully functional internet phones, such as the Apple Computer iPhone™ technology, have been used for communication, data entry and information retrieval purposes. Unfortunately, due to a lack of market demand factors, the visually impaired individuals have been unable to participate in the personal computer, electronic device and PDA technology revolution because of the absence of a suitable data typing user interfaces that is also user-friendly and specifically designed for the visually impaired community. No manufacturer, whether for Braille users or sighted users, has provided a simple, user-friendly, electronically assisted 6 Dot Braille Cell typing interface technology compatible with personal computers, electronic devices, communication devices and PDA technologies readily available to the sighted community. Consequently, there is a need for devices usable by the visually impaired that allows the use of a practical, tactile, electronically assisted custom 6 dot Braille Cell typing user-interface designed to be used with electronic devices, particularly personal computers, electronic devices, communication devices and PDA technologies to provide to the visually impaired and assist in providing basic needs ease of communication.

### SUMMARY

Disclosed herein are different embodiments of a novel single 6 dot Braille typing user interface (UI) incorporating an electronically assisted, single, auto-refreshable 6 dot Braille Cell for Braille letters, numbers, punctuation, symbols, contractions, etc. and all other forms of 6 dot Braille inputs, the devices adapted for use in communicating with various systems and technologies for controlling and using electronic devices. It is envisioned the UI will be used, in a first embodiment, as a “thumb device” in that proficient users will quickly type on the Braille UI using their two thumbs—similar to popular PDA technologies such as the Blackberry™ Cellular Phone technology. However, there is no limitation to the use of other fingers or one or more fingers on the UI.

One embodiment of this invention comprises an electronic Braille UI module with a 6 dot Braille cell typing interface and several function buttons, used for inputting Braille key permutations and using these permutations to input instructions to be sent to other devices or used with applications on this module.

Another embodiment of this invention comprises a Braille UI system using a Braille UI module in combination with a separate electronic device, said Braille UI module hard wired or wirelessly connected to the electronic device. The Braille UI module is functionally compatible with the electronic device so that 6 dot Braille cell data inputs and instructions entered into the UI are received by the electronic device for subsequent transmission. For example, a Braille input can be transmitted by the electronic device as a text message in the same manner that text messages are sent by sighted individuals using an electronic device.

Another embodiment of this invention comprises an electronic device case with a Braille UI module built on top of it. This case would act as a protective case on the electronic device and attach to the electronic device by “clipping” onto or “sliding over” it. The case would transfer Braille UI module user interactions through a wired connection, wireless connection, or mechanically through the case material itself to a touch screen upper surface of the electronic device.

Another embodiment of this invention comprises a Braille UI module incorporated in the upper surface of a traditional computer mouse to make possible Braille UI data inputs directly from the mouse to a personal computer or other electronic devices. This mouse could connect to a personal computer or other electronic devices either by wire or wirelessly.

These and other aspects and advantages of the embodiments will become apparent from the following detailed description and the accompanying drawings which illustrate by way of example the features thereof.

### BRIEF DESCRIPTION OF THE DRAWINGS

FIG. 1 is a view of a 6 dot Braille cell.

FIG. 2 is a view of an alphabet portion of the Braille symbols.

FIG. 3 is a perspective view of an embodiment of a Braille UI system incorporating features of the invention described herein.

FIG. 4 is a perspective view of a second embodiment of a Braille UI system incorporating features of the invention communicating Braille data to an electronic device via a data transmitting wire.

FIG. 5 is a perspective view of a third embodiment of a Braille embossed UI on top of an electronic device protective case.

FIG. 6 is a perspective view of a computer mouse including features of a Braille UI system interface.

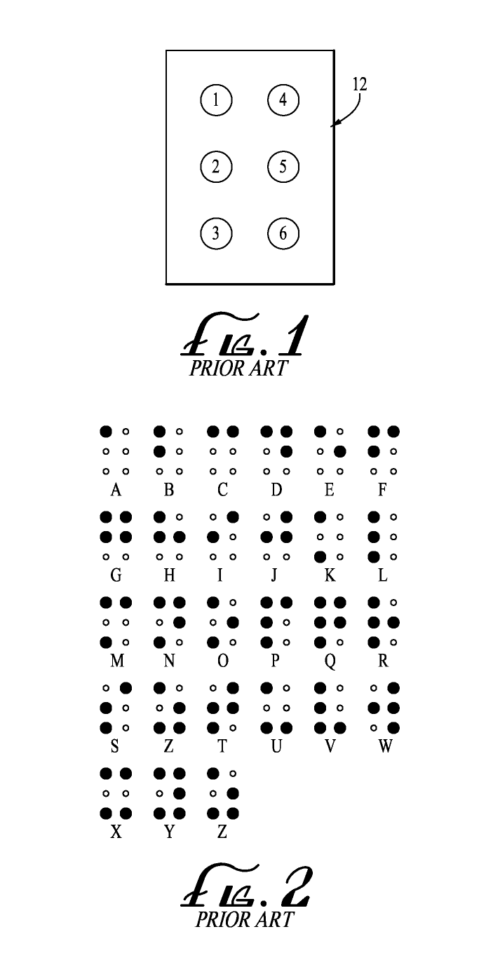

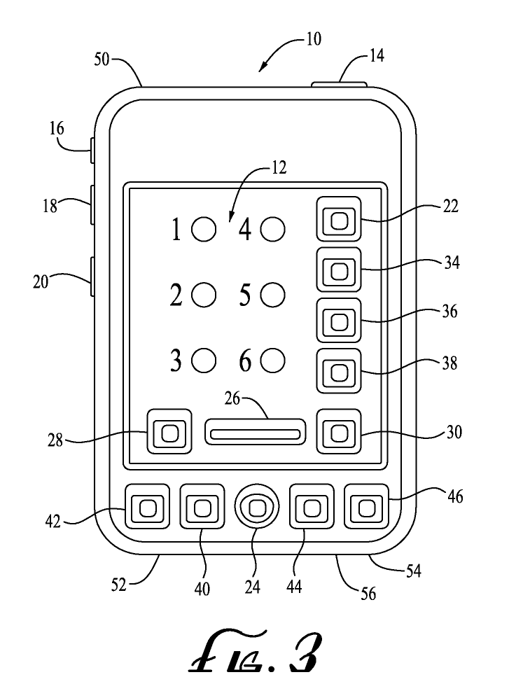

### DETAILED DESCRIPTION

Presented herein is a novel single 6 dot Braille User Interface (UI) for inputting Braille letters, numbers, punctuation marks, symbols, Braille contractions and all other forms of 6 dot Braille into electronic devices. This novel UI can be used in conjunction with personal computers, an electronic device, such as a PDA device, to allow visually impaired users to simply, quickly, accurately and discretely type information or commands into or be sent to an electronic device or devices. It is envisioned that, in a preferred embodiment, the UI will be used as a “thumb device” in that proficient users will quickly type on the Braille UI using their two thumbs—similar to popular PDA technologies such as the Blackberry™ Cellular Phone technologies. However, nothing herein is intended to limit data entry to the use of the thumbs and other fingers can be used and multiple fingers may be used either simultaneously or serially.

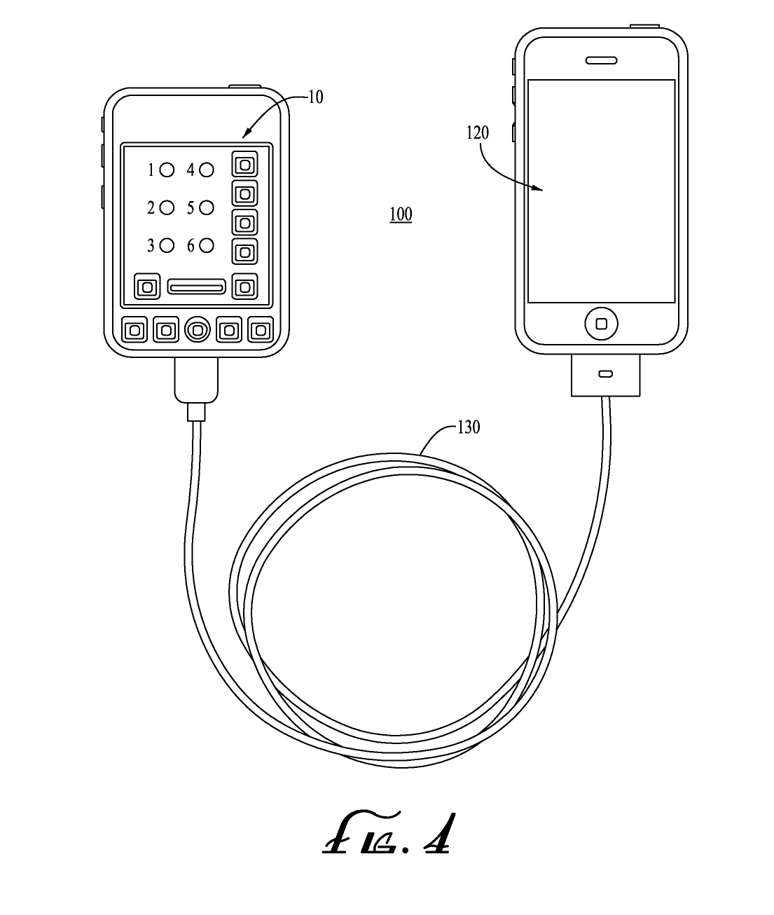

The single 6 dot Braille cell UI incorporating features of the present invention in a preferred embodiment is intended to mirror that of traditional universal 6 dot Braille Cells. (See FIG. 3). The UI is auto-refreshable in that the dots, keys and buttons, comprising the tactile nature of the novel UI, will auto-refresh themselves the same way the buttons and keys on a standard “landline” telephones or other electronic entry devices do.

The present invention is described herein with reference to certain embodiments but it is understood that the invention can be embodied in many different forms and should not be construed as limited to the embodiments set forth herein. In particular, the present invention is described below in regards to a single 6 dot Braille UI and electronic device systems in communication therewith, but the UI systems can be used in many applications other than electronic devices. Embodiments of the present invention are also described as being structured in a particular manner and communicating in a particular way with electronic devices, but it is understood that the invention can be structured in many different ways and can be configured to communicate with devices in many different ways presently utilized or developed in the future including, but not limited to hard wire, fiber optics, radio signals, infrared transmission, etc, such as are used for cell phones, computer peripherals and media control (i.e., TV) connections. The present invention is also described with reference to certain features arranged in certain ways, but it is also understood that the features can be arranged differently, different features can be used or features can be eliminated without compromising the scope of the invention set forth herein.

It is also understood that when an element is referred to as being “on” or “connected to” another element, it can be directly on the other element or intervening elements may also be present. Furthermore, relative terms such as “inner”, “outer”, “upper”, “above”, “lower”, “beneath”, and “below”, and similar terms, may be used herein to describe a relationship of one layer or another region. It is understood that these terms are intended to encompass different orientations of the device in addition to the orientation depicted in the figures.

Although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Embodiments of the invention are described herein with reference to certain view illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing. Thus, the regions illustrated in the figures are schematic in nature and their shapes are not intended to illustrate the precise shape of a region of a device and are not intended to limit the scope of the invention.

FIG. 3 shows one embodiment of a single 6 dot Braille UI module 10 incorporating features of the present invention comprising a 6 dot Braille key cell 12. The Braille UI system can also include an “on/off” switch 14, which can default to a voice command or verification “on” or “off”, a “mute” switch 16, a “volume-up” switch 18, a “volume-down” switch 20, and various function keys including but not limited to a capitalization key 22, select key 24, space key 26, return/enter/line down key 30, number key 36, punctuation key 38, voice activation key 40 and keys to turn on GPS 42, connect to email 44 and access a note pad 46. Each of these keys are preferably tactile, meaning there presence and activation can be physically felt by a user's fingers. An added preferred feature is a tactile or audio signal indicating that a pin or key that has been depressed was sufficiently depressed to be recognized by the system. Alternatively, certain keys may have multiple functions. For example, the on/off function, volume up and volume down functions can be combined in one or two switches. Additionally, the Braille UI module 10 typically includes a speaker 52 and has various connection points, typically ports for attaching other devices such as a headset port 50, microphone port 54 and USB port 56.

The keys, features, switches, etc listed above are included in a preferred embodiment. However, one skilled in the art will recognize that some of the keys, features, switches, etc can be eliminated, differently located, others may be added or multiple functions may be activated by a single key or depressing two or more specified keys at the same time. For example, depressing the on/off switch while simultaneously depressing the space key could deactivate the Braille function of the 6 dot key cell 12 and activate other software for different functions or alternative modes. For example, in an alternative mode the 6 dot key cell 12 can function as a TV or multimedia remote control device or as a universal remote controller for activating and deactivating other electronic systems such as, but not limited to, activating a home alarm system, unlocking a door to allow access to a visitor, checking on/off status of area lighting as well as numerous other functions incorporated in remote control systems provided for sighted individuals.

The 6 dot Braille UI key cell 12 has, buttons designated 1, 2, 3, 4, 5, and 6, corresponding to a standard Braille UI Cell key entry arrangement, which are auto-refreshable, like the entry buttons on a push button landline telephone, and oriented to mirror the traditional 6 Dot Braille Cell. Therefore, the orientation, and preferred dimensions, of this embodiment of a tactile, auto-refreshable UI device includes dotted numbers 1, 2, 3, 4, 5, and 6, respectively, comprises a 6 dot Braille UI key cell 12 consisting of a vertical rectangle that is split equally into two columns down the middle of the rectangle. The dot positions are universally numbered 1-3, from top to bottom in the left vertical column, and universally numbered 4-6, from top to bottom in the right vertical column.

Typical dimensions are:
a. Dot, key or button height on the UI of about 0.5 mm,
b. A horizontal and vertical spacing between the 6 dot centers within the Braille cells of about 1.5-3.0 mm, preferably about 2.5 mm.
c. A blank space between dots, keys and buttons adjacent to one another will be at least about 2.5 mm, preferably about 3.75 mm horizontally and about 5.0 mm vertically.

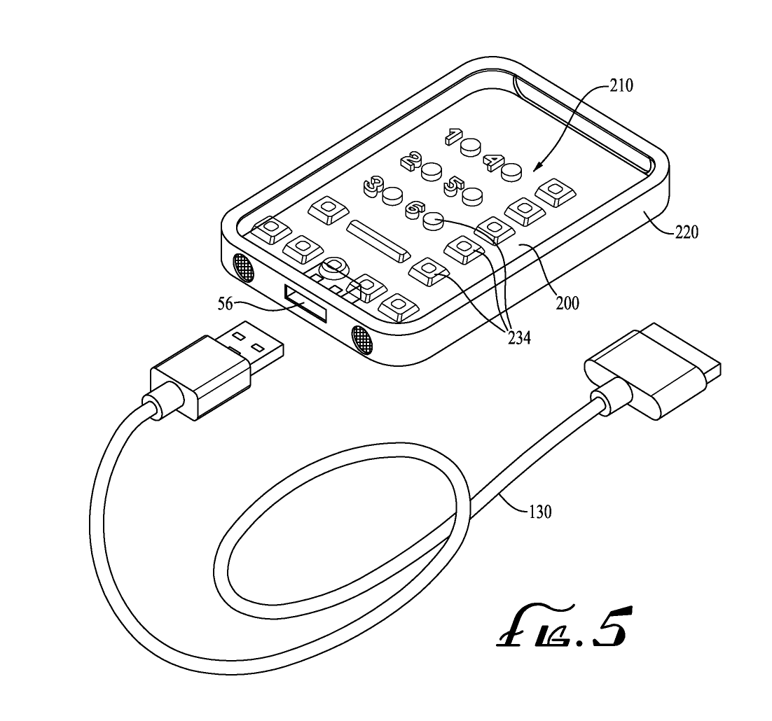

FIG. 4 shows another embodiment of a single 6 dot Braille UI system 100 (“Braille UI system”) incorporating features of the present invention. Braille UI system 100 comprises a Braille UI module 10 connected to an electronic device 120, such as a PDA or personal computer, by a data transmitting wire 130. Alternatively the connection to the electronic device 120 can be wireless, such as through RF, RFID, Bluetooth and internet technologies thus eliminating the need for the wire 130. The Braille UI module 10 is the same as or similar to the Braille module described above including the single 6 dot Braille key cell 12 user interface, which may include further keys or functions for interacting with the electronic device 120.

As a further variation, the Braille UI module 10 can comprise a series of six electronic actuators (not shown) packaged within the module 10, positioned to be activated by user contact on a corresponding one of the Braille UI module 10 dots 1-6. Pressing a dot or dots causes the electronic actuators to send the entered Braille input to the electronic device 120 for further transmission, as Braille output or translated letter output to third parties or other devices for storage and/or display.

Braille UI system 100 can include the 6 dot Braille to Roman alphabet, Arabic number, Metric, Imperial, etc. and Braille contraction language conversion application stored either in the Braille UI module 10 or stored on the electronic device 120 utilizing the particular electronic device's compatible programming platform(s) as is commonly done in the art.

As a further alternative, the Braille UI module 10 can comprise haptic vibration technology. “Haptic” vibration technology allows the UI module 10 to communicate to the electronic device 120 via vibrations emitted from the Braille UI module 10. Incorporating haptic vibration technology into the Braille UI module 10 enables the user to perform data input and data output, via distinct vibrations, on the same Braille UI 12, located on top of the same Braille UI module 10. In such an embodiment a preferred embodiment vibration duty cycle is approximately 0.1-0.15 seconds between different vibrating dots on the Braille UI Module 10.

As an example, before or after connection of the Module 10 to the electronic device 120, to set up the interaction between the Braille UI Module 10 the 6 dot Braille to Roman alphabet, Arabic numeral, Metric, Imperial, etc. and Braille language contractions language conversion application software are loaded onto the electronic device 120. Alternatively, the Braille UI module 10 and/or the electronic device 120 can be provided with the software preloaded. Furthermore, the electronic device 120 can be programmed to automatically recognize “new hardware” when the Braille UI module 10 is connected. Alternatively, the Braille UI Module 10 can be automatically recognized by the electronic device 120 so that it loads the language conversion application or the user can depress a connect button on either the electronic device 120 or Braille UI Module 10 to load or synchronize (“sync”) the Braille to language conversion application from one component to the other component.

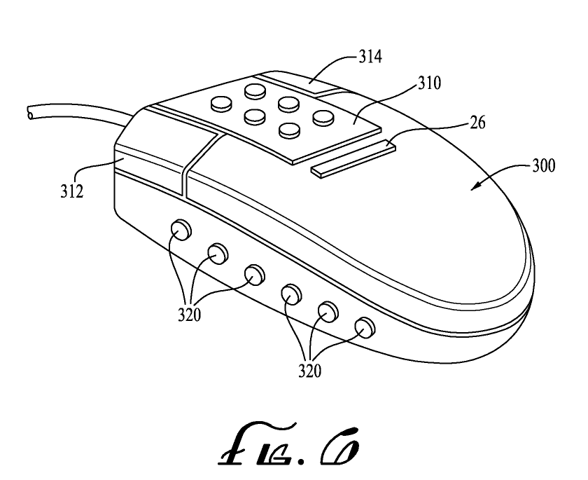

Referring to FIG. 5, another embodiment is shown including a 6 dot Braille Electronic Device Protective Case 200 positioned atop the electronic device 220 to provide a unitary structure 210. The 6 dot Braille Electronic Device Case 200 incorporates on and in its surface the features and functions, namely the surface mounted dots and keys, of the Braille UI module 10. In one embodiment the Electronic Device Case 200 is a small, handheld package, with dimensions in a preferred configuration of about 1.75×2.25×0.4375 inches. The Electronic Device Case 200 would provide protection for the electronic device 220, such as a PDA, as well as provide a direct communication of data entry between the UI module 10 features and functions of the Braille Electronic Device Case 200 to the electronic device 220 while mated directly thereto. Entries made on the Module 10 features of the Braille Electronic Device Case 200 can be delivered directly, through a plug and port or wire connection (not shown), for example to an existing data port (i.e. a USB port) of the electronic device 220 or wirelessly to a personal computer or electronic device 220 enabling users to use a single composite unitary device 210 comprising both the electronic device 220 with the Electronic Device Case 200 placed symmetrically atop the operating surface or on the rear surface of the Electronic Device 220. In this manner the user does not have to remove a separate case from the electronic device 220 because the Electronic Device Protective Case 200 provides that function and allows for other ports to remain open for battery re-charging, internet portal syncing, etc.

The Electronic Device Protective Case 200, which can be provided as a sleeve for placement around the electronic device 220, or can be snapped or attached onto the electronic device 220, has the same functionality as the Braille UI Module 10 in communication with a personal computer or electronic device 120 via a wire or wirelessly.

In a variation of the assembly as shown in FIG. 5, where the Electronic Device Protective Case 200 is placed over an electronic device 220 with a touch screen which is heat sensitive, such as a touch screen note taking and reading pad or PDA, for example, an Apple® iPhone® PDA. The electronic device protective case 200 may be made of a material which transfers heat, such as a thin acrylic material so that finger contact with the Electronic Device Protective Case 200 can be directly transferred to the =ouch screen through the heat transferring case material. In such an embodiment, the surface of the Electronic Device Protective Case 200 has raised features 230 (to avoid confusion only three of these raised features are labeled in FIG. 5) to simulate buttons to provide tactile targets for the fingers for Braille entry and activation of the features by user. In a still further variation, each of the raised features may include within the raised portion, means for signaling activating contact such as a vibrator mechanism, for haptic or vibration data feedback, or a “clicker” emitting a sound or signal that can be sensed by the finger tips. The embodiment may also include a data cable 130 along with a suitable port 56 for transfer of information from the unitary structure 210 to a personal computer or other electronic devices such as PDAs. As a still further alternative, the Electronic Device Protective Case 200 can be adapted to function with an electronic device 220 having a pressure surface for receiving finger contact input.

For electronic devices 220 with touch screens the Electronic Device Case 200 can be structured to not cover the portions of the electronic device's 220 touch screen user-interface so as to make some of the electronic device's 220 touch screen functionality still available to the user while providing the Braille UI Module 10 to the user for additional data input and data output functionality. This design allows the user use of their electronic devices 220 without requiring the user to flip their electronic device 220 upside and downside to have access to both the Braille UI Module 10 in addition to other visually impaired applications and technologies that may be designed into the electronic device's 220 simulated electronic raised surface for their touch screen. This embodiment can include all functionality similar to that in embodiments shown in FIG. 5.

As a still further alternative the electronic device can be a computer mouse such as shown in FIG. 6. The Braille UI Module can be mounted or clipped on top of the surface of a traditional personal computer or laptop mouse as a protective case that can communicate with personal computers via a wire or wirelessly. Furthermore, the Braille UI module can be embossed on top a touch screen electronic note pad or on top of a laptop touch screen finger mouse/cursor feature found on most modern laptops. As a further alternative a Braille UI mouse 300 such as shown in FIG. 6, can be provided. This embodiment comprises a 6 dot Braille key cell 310 built into a traditional computer “mouse.” The Braille UI mouse 300 functions as a traditional computer mouse with the left and right buttons 312, 314 having the typical mouse functions but with the unique Braille UI Module capabilities built into its surface and/or sides of the traditional mouse UI designed for the sight community. Referring to FIG. 6 an embodiment of a Braille entry computer mouse set up to a right handed individual is shown. A space bar 26 is mounted in the upper surface of the mouse 300 below the Braille key cell 310 and several function keys 320, such as those shown in FIG. 3 are located within the left side of the mouse 300 so that they can be thumb activated. Additional function keys 320 can be located in a similar manner along the right side. The functions of each of the function keys 320, as well as the left and right buttons 312, 314 can be programmed by the user to suit their personal preference or to better adapt the mouse for use by a left handed individual.

The Braille UI module 10 or the module 10 in combination with other components of the various UI system embodiments described above can all function in the same general manner, provide substantially the same data entry capability and can be programmed to added additional features and functions. For simplicity the operation of the module 10 or the module 10 in combination with the other components of the Braille UI systems are described below by reference to the module 10. However, it is not intended to limit the operation of the module 10 and it may be provided in part by other components of the Braille UI system. All of the embodiments can provide voice verification of Braille UI key entries typed into the system. For example, when a user types the letter “m” in Braille, a real-time voice verification of data entry or data output is provided by speaker 54 or through earphones attached to the head set port 50. Whole words can be quickly typed with accuracy while voice verification serves as an accuracy “double check” feature. For example, to enter the capitalized word “Dream” using the Braille UI module 10, the user first depresses the ‘Caps’ function key 22 and then depress the “Select” key 24. A voice verification feedback announces “Capital letter”. The user then depresses the number 1, 4 and 5 dots on the 6 dot Braille key cell 12 followed by pressing the Select key 24. This generates a voice verification announcement “capital D”.

In a like manner, the dot arrangement for the next letter is pressed followed by the select key 24. For example, the numbers 1, 2, 3 and 5 dots (r), 1 and 5 dots (e), number 1 dot (a) and then numbers 1, 3 and 4 dots (m), each combination of dots being followed by the Select key 24. After each select key 24 entry a voice verification announces the letter entered by depressing the selected dots. The above series of entries results in a voice verification of the entry of “capital D”, “r”, “e”, “a” and “m”. To identify completion of a term the Spacebar key 26 is depressed. Alternatively, the Braille UI module can be instructed to provide a voice verification of an entire word generated or both the letters and the word formed.

It should be recognized that depressing one or more dots to enter a letter may be accomplished either simultaneously or in series or a combination thereof, the subsequent depression of the select key 24 designating that the immediate prior depressed dots are to be entered into the system as a single entry, and the next set or series of depressed keys provides entry of a new letter, number, punctuation, symbol, Braille contraction etc. The select key 24 on the Braille UI module 10 indicates a particular action is to be taken. Generally speaking, the select key 24 functions as the commonly understood “command” key. Moreover, it also prompts voice verification to the user to indicate that a particular action has been taken. Automatic cursor movement, from left to right, after a character is inserted within a term occurs, as commonly seen with standard, off-the-shelf, personal computer and PDA technologies designed for the sight community. The spacebar key 26 functions as the “string key” enabling the user to arbitrarily add spacing before and after data inputs in order to type various Braille symbols, contractions, etc.

The Braille UI module 10 provides for deletion of one or more user data entries at a time by depressing the “Back” button 28 or movement to the next line of entered characters by pressing the “Enter” key 30. Voice verification feedback of a complete term, sentence, paragraph or even an entire document can be performed by depressing the Select key 24 twice (or an alternative entry) after an entry is completed. The Braille UI module provides a signal transmission component, such as head set port 50, so users can connect standard headphones, either wired or wireless, for receiving voice verification, voice instructions, or other communications privately. The signal transmission component can also be configured to feed external speakers or to provide a display of entered information on a personal computer screen or other electronic devices such as PDAs.

With the Braille UI module 10, 6 dot Braille contractions can also be quickly and easily entered by users. By selecting the “letters” key 34, the system extends its interpretation of 6 dot Braille key entries beyond standard 6 dot Braille characters to include all common Braille capitalization, letters, numbers, punctuation, symbols, contractions, etc, to include the complete Grade I and Grade II Braille sets of Braille contractions, or any other newly established Braille protocols, thus eliminating the need for additional, unnecessary, dots, keys or buttons on the Braille UI module 10.

Use of the Spacebar key 26 as the string-key allows entry of all 6 Dot Braille capitalization, letters, numbers, punctuation keys—which will include all Braille symbols and contractions. For example to enter a Braille contraction Spacebar 26 is depressed to enter an empty space followed by depression of the dots necessary to indicate a Braille contraction. This is followed by the depression of the dots needed to generate the Braille contraction, followed by depressing the Spacebar 26 to enter another empty space and depress the Select key 24 for voice verification of the Braille contraction entry. As with standard letter entries, voice verification follows each contraction entry. The UI module 10 also provides the user the ability to program personal user settings and to select specific words, phrases, etc., according to their preferences.

For example, to enter the single letter contraction for “knowledge” the user depresses the Spacebar key 26, making an arbitrary space, followed by selecting the 6 dot Braille Contraction symbol for the term “knowledge” or “k” i.e. 1, 3, followed by the Braille contraction sign for “knowledge” which happens to also be the letter “k” or 1, 3. User depresses the Spacebar key 26 to generate another arbitrary space and depresses the Select key 24 to obtain a voice verification of the whole word single letter Braille contraction “knowledge.”

Similar procedures can be followed when entering a single word as a two letter Braille contraction, for example, the word “child” can be represented by the two letter Braille contraction for child or “ch” i.e. 1, 6. User depresses the Spacebar key 26 to generate an arbitrary space, followed by the Braille Contraction symbol for the term “child” or c i.e. 1, 4, followed by depressing the Braille Contraction for “child” i.e. 1, 6, followed by depressing the Spacebar key 26 to generate another arbitrary space, user depresses the Select key 24 to obtain a voice verification of the whole word two letter Braille contraction for the word “child.”

As a further feature, double depressing the CAPS key 22 sends a command to capitalize a series of letters, an entire term, sentence, paragraph and will remain active or “Caps on” until the Caps key 22 is depressed a third time to turn “off” the Caps function and also generate a corresponding voice verification “Caps off”. No overlap or conversion occurs between the Braille entry algorithm and the function keys—i.e. the space key 26, capitalization key 22, select key 24, etc. because these keys use an entirely different programming language and/or software programming platform altogether.

Furthermore, the module can incorporate common letter combinations, term entries, term suggestion algorithms beyond traditional 6 Dot Braille contractions and other methods of truncating Braille in its various forms, whether modern or traditional. All key entries and software promoted key entry suggestions can provide the user with custom voice verification feedback default options. As noted above, the voice verification default option may be customized by the user to be activated according to particular user-specified default preferences for convenience purposes, etc.

The Braille UI module 10 also provides email synchronizing capability 44 allowing the Braille UI module 10 to be pre-programmed to “sync” with the various major internet email providers. Braille UI module 10 includes designated numbers preprogrammed for particular major email providers, for example 1=Yahoo, 2=Google, 3=AOL, 4=Apple, etc. This allows the Braille UI module 10 to be set to enable users to quickly and easily pre-program and set-up a personal email account with the Braille UI module 10 similar to many PDA technologies for the sighted.

For example, the Braille UI module 10 can be set up so that when the user depresses the personal “email” function key 44, certain letters i.e. 1, 2, 3, 4, 5, 6, etc., as described above, can be pre-programmed to quickly sync email accounts to particular major email providers—e.g. Google, Yahoo, AOL, Apple, etc. For example, if the system is preprogrammed to use dot 1 of the 6 dot Braille key cell to access Yahoo™ for Email correspondences, if the user wants to use Yahoo, they would depresses the number 1 dot, the Select key 24, which generates a voice verification “Yahoo email.” The user is then guided through a simple pre-programmed Yahoo email set-up to quickly plug in their personal email information. Alternatively the Braille UI module 10 can be set-up to automatically enter user email access information once the entry sequence is activated.

The Braille UI module 10 can further include the ability to wirelessly connect to or send instructions to other electronic devices allowing users to remotely control other pre-programmed activities such as adjusting the temperature in a room of a house, turning on or off an oven or stove, controlling components of a media system, etc.

We claim:

1. A user interface system for Braille entry to electronic devices comprising:
a module with a single set of six tactile keys arranged in a 6 dot Braille configuration;
said user interface system configured to recognize data entered therein by user contact with one or more of the tactile keys as Braille input and to transmit said Braille input to an electronic device for display or further transmission.

2. The system of claim 1 further comprising one or more audio outputs and one or more optional visual outputs.

3. The system of claim 2, wherein said one or more audio outputs and one or more optional visual outputs provides voice and visual verification of said Braille key inputs.

4. The system of claim 2, wherein said one or more audio outputs comprises one or more of a headphone port and audio speakers and said one or more or visual outputs comprises a visual display.

5. The system of claim 1, wherein said module further comprises one or more components for input of volume adjustment, power adjustments, adding capitalization, word spacing, line spacing, punctuation and text correction to text output generated by Braille key inputs.

6. The system of claim 1, wherein said system is configured of interpreting Braille inputs as Braille contractions.

7. The system of claim 1, wherein said system is configured programmed to recognize all possible 6 dot Braille permutations inputs and to transmit said inputs as audio or visible letter outputs.

8. The system of claim 1, wherein the module is pre-programmed to receive or load functional applications.

9. The system of claim 8, wherein said functional application includes email syncronization with email providers.

10. The system of claim 1, wherein said system interfaces with said electronic device through one or more of a data transmission cable, wirelessly or using a touch screen overlay.

11. The system of claim 1, wherein said Braille key inputs include an auto-refresh function.

12. A user interface system for Braille entry, comprising:
a module comprising a single set of six independent input keys arranged in a two-by-three side by side relationship;
said input keys utilizing electronic actuators or haptic vibrators for transmission of user contact with one or more of the six input keys to an electronic device in communication therewith.

13. The system of claim 12, wherein the module communicates with an electronic device and utilizes application software stored on said electronic device.

14. The system of claim 13, wherein said electronic device substantially simultaneous converts activation of said inputs keys in a manner conforming to a Braille character to a corresponding alphabet letter.

15. The system of claim 13 wherein said electronic device converts activation of said inputs keys conforming to a Braille numerical character to a number.

16. The system of claim 13, wherein electronic device converts activation of said inputs keys conforming to a Braille entry to voice verification of said letters or words formed by said input key activation.

17. The system of claim 13, further comprising audio outputs.

18. The system of claim 17, wherein said audio outputs are hard wired or are connected to said module by wireless communication.

19. A Braille User Interface system, comprising:
an electronic device case,
said case further comprising tactile entry points corresponding to keys in a 6 dot Braille input array, said case capable of interfacing with an electronic device.

20. The system of claim 19, wherein said electronic device has a touch sensitive screen responsive to heat and the case is positioned over said electronic device touch sensitive screen with the tactile entry points interfacing with the touch sensitive screen.

21. The system of claim 20, wherein at least said tactile entry points comprise a material capable of transmitting sufficient heat from a user's fingertips to activate the heat responsive touch sensitive screen.

22. The system of claim 19, wherein said electronic device has a pressure sensitive screen responsive to finger pressure and the case is positioned over said electronic device touch sensitive screen with the tactile entry points interfacing with the pressure sensitive screen.

23. The system of claim 22, wherein at least said tactile entry points comprise a material or mechanism capable of transmitting sufficient pressure from a users fingertips to activate the pressure responsive touch sensitive screen.

24. The system of claim 19, wherein the interface is a signal conductive component interconnecting data ports on the electronic device and the case for exchange of data.

25. The system of claim 19, wherein said case wirelessly exchanges data with said electronic device.

26. The system of claim 19, wherein communication between the case and the electronic device does interfere with the access to an electrical charging port on said electronic devices.

27. The system of claim 19 wherein said case covers only a portion of the screen of said electronic device.

28. The system of claim 19 wherein said electronic device is a computer mouse.

29. A method of converting Braille input to letters or words as sound output or a visual display comprising:
providing a Braille input module comprising a single array of six independent input keys arranged in a two-by-three side by side relationship said array in communication with Braille translation software;
providing digital contact to the six independent input keys to generate a Braille output recognizable by the Braille translation software, said Braille translation software converting said Braille output to an electronic output.

30. The method of claim 29 wherein the electronic output comprises a visual display of Roman alphabet characters and number characters in the form of a written display.

31. The method of claim 29 further comprising transmitting the Braille input to an electronic device.

32. The method of claim 29 further comprising providing an audio or video output.
